(19) United States
(12) Patent Application Publication
(10) Pub. No.: US 2015/0379627 A1
(43) Pub. Date: Dec. 31, 2015

(54) INTEGRATED FINANCIAL APPLICATION MANAGEMENT DEVICE

(71) Applicant: Bank of America Corporation, Charlotte, NC (US)

(72) Inventors: Dharmender Kumar Satija, Rye Brook, NY (US); Ashwin Roongta, East Brunswick, NJ (US); Chris Butler, Cornelias, NC (US)

(21) Appl. No.: 14/317,927

(22) Filed: Jun. 27, 2014

(51) Int. Cl. G06Q 40/00

(52) U.S. Cl. CPC G06Q 40/00

(57) ABSTRACT

An integrated financial application management device having a consolidated system that may allow users to access one or more financial applications and/or functions, wherein said users are subject to different regulations governing access to various types of financial information. The integrated financial application management device may provide a tailored user interface such that information that is visible to the user is customized based upon login information identifying a user as, among others, a customer of a financial institution, a fiduciary, or a broker-dealer.

### TECHNICAL FIELD

Aspects of this disclosure generally relate to systems and methods for providing access to one or more financial applications by a consolidated device, wherein access to the one or more financial applications may be regulated by a third-party regulatory body.

### BACKGROUND

Financial institutions may utilize a plurality of different software applications and processes to provide products and/or services to various different types of customers. For example, a financial institution may provide fiduciary services, in addition to broker-dealer services to different customers, or to a single customer. As such, in one example, separate software applications, tools, and databases may be maintained by a financial institution to service those separate fiduciary and broker-dealer branches of the financial institution. In one example, these separate software applications, tools, and databases may be maintained in order to comply with different regulatory standards between those products and services associated with a fiduciary, and those associated with a broker-dealer. Accordingly, a financial institution may maintain duplicated and/or fragmented information for a single customer. As such, input and maintenance of this duplicated and fragmented customer data may represent an area of inefficiency in the financial institution.

Therefore, a need exists for a device for improved access to financial applications and/or databases across different branches of a financial institution, including one or more of a broker-dealer branch, and a fiduciary branch.

### BRIEF SUMMARY

In light of the foregoing background, the following presents a simplified summary of the present disclosure in order to provide a basic understanding of some aspects of the various implementations of this disclosure. This summary is not an extensive overview of the embodiments described herein. It is not intended to identify key or critical elements, or to delineate the scope of the embodiments described in this disclosure. The following summary merely presents some concepts of the embodiments of this disclosure in a simplified form as a prelude to the more detailed description provided below.

An integrated financial application management device may have a consolidated system that may facilitate access, by one or more users, to one or more financial applications and/or functions. As such, the one or more users may be subject to different regulations governing access to various types of financial information. The integrated financial application management device may provide a tailored user interface such that information visible to the user is customized based upon login information identifying a user as, among others, a customer of a financial institution, a fiduciary, or a broker-dealer.

Aspects of this disclosure address one or more of the issues mentioned above by disclosing methods, systems, non-transitory computer readable media, and apparatuses for establishing compatibility between an open-source data warehouse and a proprietary data warehouse. Aspects of the disclosure may also be provided in a non-transitory computer-readable medium having computer-executable instructions to perform one or more of the process steps described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements.

FIG. 1 shows an illustrative operating environment in which various aspects of the disclosure may be implemented.

FIGS. 2, and 2B-2C are schematic block diagrams of an integrated financial application management device.

FIG. 3 is a flowchart diagram of a process utilizing an integrated financial application management device to provide access to client summary information.

FIG. 4 is a flowchart diagram of a process utilizing an integrated financial application management device to provide access to information associated with financial products purchased by a user.

FIG. 5 is a flowchart diagram of a notification process.

### DETAILED DESCRIPTION

As discussed above, a financial institution may utilize a plurality of different software applications and/or processes to provide financial products and/or services to different customer types. As such, as described herein, a financial institution may comprise one or more of a commercial bank, an investment bank, an insurance company, a brokerage, an investment company, a unit investment trust, a management investment company, or a credit union, among others. Accordingly, the types of financial products and/or services offered by a financial institution may comprise, among others, securities, including debt securities, equity securities, and derivative contracts (forwards, futures, options, and the like), a financial trust (e.g. a living trust, and the like), a debt financial instrument (personal loan, business loan, and the like), or combinations thereof. However, those of ordinary skill in the art will recognize various additional financial products and/or services which may be offered by a financial institution, wherein said financial products and/or services may be utilized without departing from the disclosures described herein.

In one example, a financial institution may comprise, among others, a fiduciary portion (otherwise referred to as a “branch”), and a broker-dealer branch. Accordingly, the fiduciary branch may be utilized to, among other things, provide financial services to private clients related to financial trust products. Additionally, those of ordinary skill in the art will understand various responsibilities associated with a fiduciary, and the like. In one example, a fiduciary may be subject to regulations provided by, among others, the Office of the Comptroller of the Currency (OCC) in the United States of America. In another example, a fiduciary may be subject to regulations provided by another regulatory body, wherein equivalent and/or alternative regulatory bodies for financial fiduciaries in the United States of America, and elsewhere throughout the world, will be known to those of ordinary skill in the art. A broker-dealer branch of a financial institution may be utilized to provide services related to buying and selling securities for customers of the financial institution, and the like. Accordingly, in one example, a broker-dealer may be subject to regulations provided by the United States Securities and Exchange Commission (SEC). However, those of ordinary skill in the art will recognize various additional and/or alternative regulatory bodies that may provide regulations governing a broker-dealer of a financial institution in the United States, or elsewhere throughout the world.

In one example, a financial institution comprising a fiduciary branch and a broker-dealer branch may be subject to regulations (from one or more regulatory bodies including, for example, the OCC and/or SEC) governing the type of information that may be made available to an employee of the financial institution or a customer of the financial institution. Accordingly, said regulations may outline those types of information accessible based upon, among others, a job title, a job function, or a credential of an employee of a financial institution (wherein a job title, a job function, or a credential may relate to a fiduciary responsibility of the employee, a level of seniority of an employee, one or more roles and/or responsibilities of an employee, data access privileges associated with an employee, a division within a larger corporate structure associated with an employee, among others) and/or a type of financial product/service in question. For example, information related to a blind trust may not be made available to a trust beneficiary and may only be made available to the blind trust fiduciary, and the like.

Conventionally, in order for a financial institution to comply with various sets of regulations related to the visibility of financial information (i.e. who may have access to said information based upon a customer type or a job role within a financial institution, and the like), the various software applications and/or databases associated with financial products and/or services having different regulations (otherwise referred to as “conflicting” regulations) may be operated and maintained fully separately. In this way, in one example, multiple databases of substantially similar information related to a customer may be separately-maintained by a financial institution. In one example, these separately-maintained databases may be stored on separate physical hardware and/or accessible from separate user accounts, and the like. Further, a financial institution may utilize separate implementations of a same financial software product on separate hardware and/or separate computer user accounts in order to maintain a regulated division between, in one example, a fiduciary branch and a broker-dealer branch of a financial institution. In this way, a financial institution may conventionally expend time and/or resources inputting customer information into, as well as maintaining separate software applications and/or databases, wherein these practices represent an area of inefficiency for the financial institution.

Advantageously, the systems and methods described herein relate to an integrated financial application management device having a consolidated system for accessing one or more financial applications and/or functions by users subject to differing financial regulations. As such, the integrated financial application management device described herein provides a tailored user interface such that information visible to the user (said information including customer information and/or financial applications and functions) is customized based upon login information identifying a user as, among others, a customer of a financial institution, a fiduciary, or a broker-dealer.

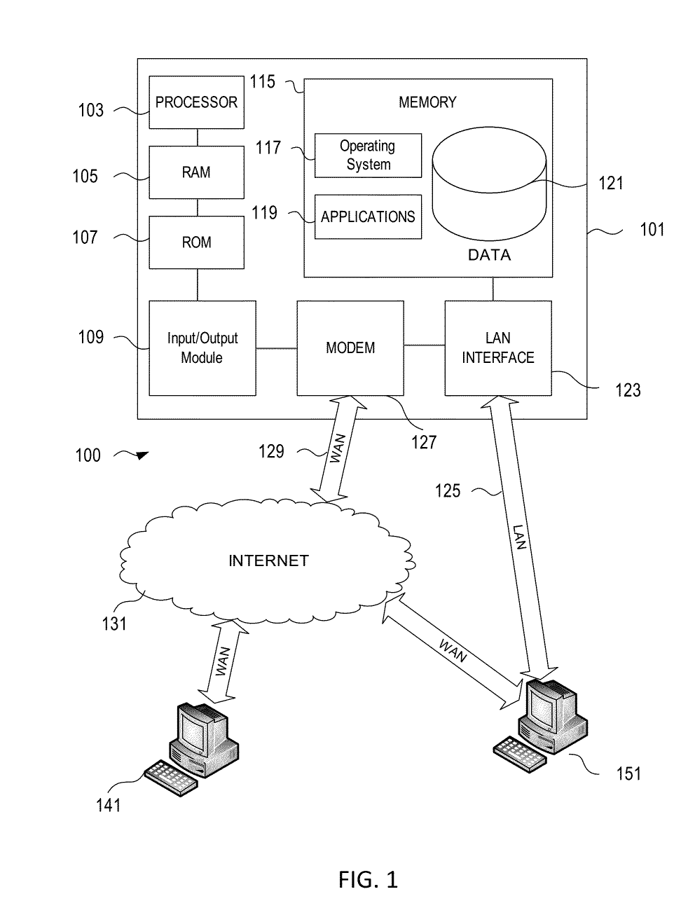

In the context of this disclosure, an integrated financial application management device may comprise hardware, firmware, and software utilized to consolidate, and provide tailored access to, one or more financial applications and/or functions to a user, based upon a specific role of the user in relation to a financial institution (customer, broker-dealer user, or fiduciary user, and the like). Accordingly, with reference to FIG. 1, the integrated financial application management device may be implemented as a general-purpose or specialized computing system 100. As such, the integrated financial application management device may include one or more network-linked computer devices, such as devices 101, 141, and/or 151. Furthermore, the integrated financial application management device 100 may be implemented on consolidated computing hardware, such as computing device 101, at a single geographic location, and/or on a single integrated circuit, and the like. In another example, the integrated financial application management device 100 may be implemented across multiple computing devices at a common, or dispersed geographic locations. As such, device 100 may comprise computing devices 101, 141, and/or 151 in communication with one another using one or more networking technologies (125, 129, and/or 131) described in further detail in the description that follows.

In one example implementation, computing device 101 may have a processor 103 for controlling overall operation of device 101 and its associated components, including RAM 105, ROM 107, an input/output (I/O) module 109, and memory 115. In one example, as will be apparent to those of ordinary skill in the art, memory 115 may comprise any known form of persistent and/or volatile memory, such as, among others, a hard disk drive, a solid state disk, optical disk technologies (CD-ROM, DVD, Blu-ray, and the like), tape-based stored devices, ROM, and RAM, or combinations thereof. In this way, memory 115 may comprise a non-transitory computer-readable medium that may communicate instructions to processor 103 to be executed.

I/O module 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to the processor 103 for allowing the computing device 101 to perform various functions. For example, memory 115 may store software used by the computing device 101, such as an operating system 117, application programs 119, and an associated database 121. The processor 103 and its associated components may allow the computing device 101 to run a series of computer-readable instructions to process and format data.

The computing device 101 may operate in a networked environment supporting connections to one or more remote computers, such as computing devices 141 and 151. In one example, the computing devices 141 and 151 may be personal computers or servers that include many, or all, of the elements described above relative to the computing device 101. Alternatively, computing device 141 and/or 151 may be a data store that is affected by the operation of the computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed. Accordingly, communication between one or more of computing devices 101, 141, and/or 151 may be wired or wireless, and may utilize Wi-Fi, a cellular network, Bluetooth, infrared communication, or an Ethernet cable, among many others.

Additionally, an application program 119, used by the computing device 101 according to an illustrative embodiment of the disclosure, may include computer-executable instructions for invoking functionality related to providing a user interface having consolidated and tailored access to information and applications for providing financial services to a customer. As such the user interface may be tailored based upon login credentials to the integrated financial application management device 100.

The computing device 101 and/or the other devices 141 or 151 may also be mobile devices, such as smart phones, personal digital assistants (PDAs), and the like, which may include various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

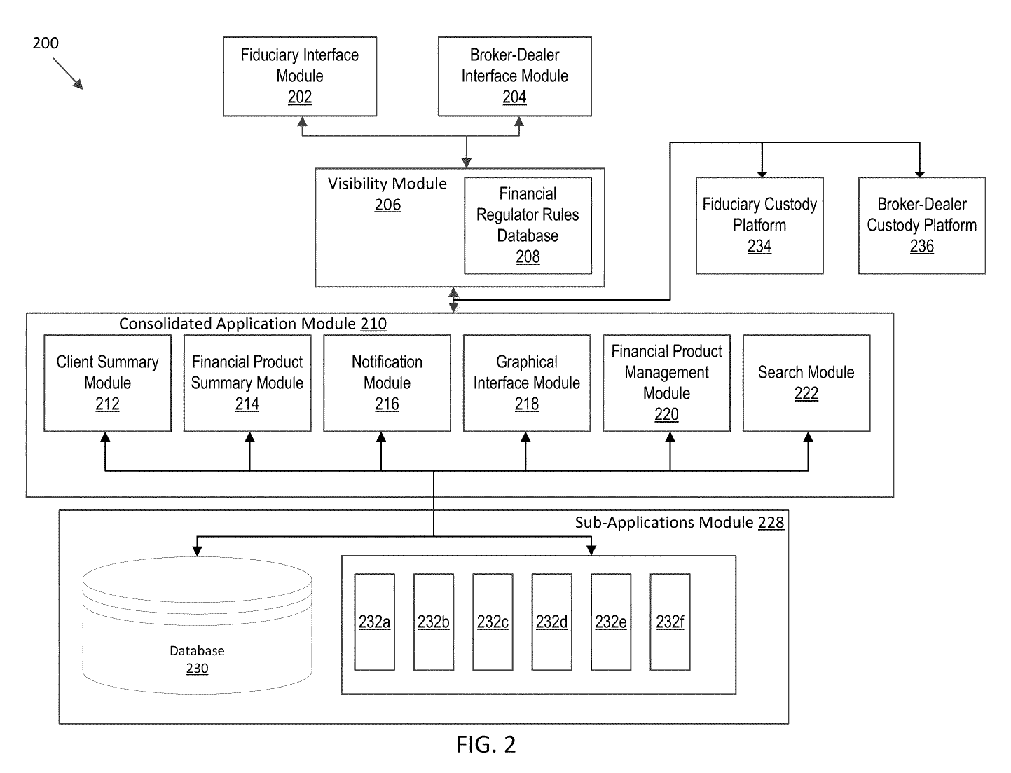

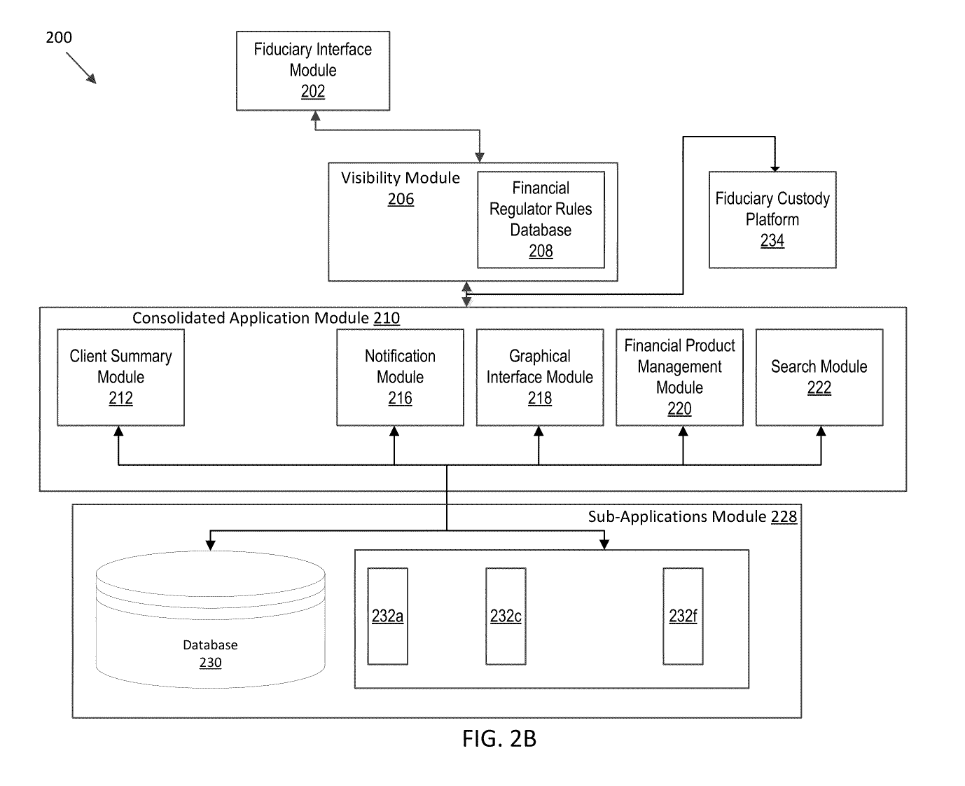

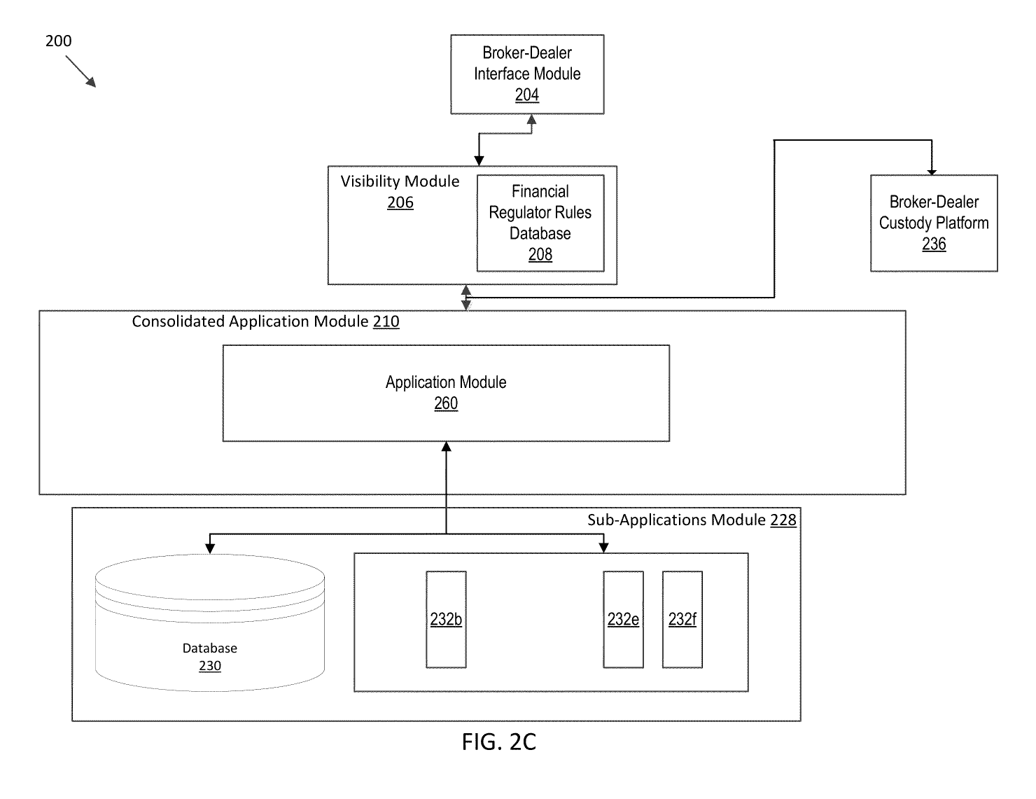

FIG. 2 is a schematic block diagram of an integrated financial application management device 200. In one example, the integrated financial application management device 200 may be similar to device 100 from FIG. 1, such that the device 200 is implemented on computing hardware similar to computing devices 101, 141 and/or 151. In one example, integrated financial application management device 200 comprises a fiduciary interface module 202 and a broker-dealer interface module 204. Accordingly, modules 202 and 204 may represent hardware, firmware and/or software configured to facilitate access to financial application management device 200 by one or more users. In one example, fiduciary interface module 202 comprises a physical interface, via a computing device, with the integrated financial application management device 200, and accessible to those users and/or clients of a fiduciary branch of a financial institution. In one example, a fiduciary branch may be located in a physically-separate location to that of a broker-dealer branch of, in one example, a same financial institution. Accordingly, module 204 may represent hardware, firmware, and/or software configured to facilitate access to financial application management device 200 by one or more users associated with a broker-dealer branch of said financial institution. These users associated with a broker-dealer branch may include financial institution employees and/or customers of the broker-dealer branch. Accordingly, in one implementation, modules 202 and/or 204 may provide for Web-based access to the financial application management device 200.

Visibility module 206 represents one or more processes executed by the computing device to facilitate a common point of entry into the financial application management device 200. Specifically, visibility module 206 executes one or more processes to allow users of different types (such as fiduciary users facilitated by fiduciary interface module 202, and/or broker-dealer users facilitated by broker-dealer interface module 204) to access a common interface. In particular, visibility module 206 may execute one or more processes to receive login credential information from a user, wherein said information is received through one or more of fiduciary interface module 202 and/or broker-dealer interface module 204. Said login credential information may include an identification of an IP address from which access is requested, a password, transmission of a security key, or combinations thereof. Furthermore, visibility module 206 may execute one or more processes providing additional and/or alternative login security measures known to those of ordinary skill in the art for verifying user login information.

In order to facilitate compliance with one or more third-party regulations (such as, for example, OCC and/or SEC regulations), visibility module 206 may further comprise financial regulator rules database 208. As such, financial regulator rules database 208 may have a data store of information and/or rules associated with users of different types (fiduciary, broker-dealer, and/or financial institution customers). For example, financial regulator rules database 208 may store rules listing one or more financial applications to which a user of a specific type may be granted access. Additionally, financial regulator rules database 208 may store rules outlining specific types of client financial information to which a user of a specific type may be granted access. Furthermore, those of ordinary skill in the art will understand that financial regulator rules database 208 may store additional rules outlined by one or more financial regulators, or other regulatory bodies, without departing from the scope of the disclosures described herein.

In response to identification and verification of a user type, visibility module 206 may execute one or more processes to access financial regulator rules database 208. As such, visibility module 206 may execute one or more processes to communicate one or more rules associated with the identified user type, from database 208, to consolidated application module 210.

Consolidated application module 210 may generate for display on a display device, a user interface. Accordingly, this user interface may provide access to one or more financial applications associated with one or more financial services and/or products offered by a financial institution to the user of financial application management device 200. Advantageously, the consolidated application module 210 may provide a common interface for users of different types, thereby reducing an amount of duplicated and/or dispersed information maintained by a financial institution in order to service users associated with different regulations. In this way, consolidated application module 210 may provide access to only those applications/information to which a user may be granted access, based upon those rules received from financial regulator rules database 208.

In one example, consolidated application module 210 may further comprise one or more sub-modules 212-222. As such, sub-modules 212-222 may provide functionality associated with one or more financial applications to which a user may be granted access. Accordingly, those depicted sub-modules 212-222 from FIG. 2 may represent a larger number of modules that may form consolidated application module 210. In one example, client summary module 212 may comprise one or more processes executed to display all information associated with an identified client. As such, client summary module 212 may execute one or more processes to generate for display, an interface providing a comprehensive summary of, among others, all financial products associated with an identified client, a schedule of actions (adjustments to financial products associated with the client, and the like) to be carried out to service the identified client, all those correspondences between the financial institution and the identified client, biographic and/or contact information associated with the identified client, among many others. Additionally, client summary module 212 may execute one or more processes configured to receive new information from a user of device 200. As such, client summary module 212 may be utilized to construct a consolidated database of client information that may be utilized across multiple different financial applications.

In another example, financial product summary module 214 may be utilized execute one or more processes for providing a comprehensive summary of, among others, past and/or predicted future performance of all those financial products and/or services associated with an identified client. As such, financial product summary module 214 may generate for display, a summary of all those securities or otherwise, associated with a client.

In one example, notification module 216 comprises one or more processes executed to provide push notifications to an identified user of financial application management device 200. Specifically, notification module 216 may be utilized to inform a user of upcoming deadlines associated with financial products and/or services, performance of one or more financial products or services, or to solicit responses from a user to one of more options related to one or more financial products and/or services. Furthermore, those of ordinary skill in the art will recognize that notification module 216 may be utilized to provide notifications to a user including information beyond that described above, and without departing from the scope of the disclosures herein.

Graphical interface module 218 may execute one or more processes to generate for display, a graphical user interface tailored to a user of a specific type. Accordingly, graphical interface module 218 may generate for display, a tailored user interface based upon an identified user type. Further, the graphical interface module 218 may generate a tailored user interface based upon an identified device from which the user is accessing the integrated financial application management device 200. As such, graphical interface module 218 may generate a first user interface for a user accessing device 200 from a desktop computer, and may generate a second user interface for a user accessing device 200 from a mobile device, including a tablet and/or a smart phone, among others.

Financial product management module 220 may comprise one or more processes configured to be executed to provide one or more options related to adjustment of one or more financial products associated with a user of device 200. For example, financial product management module 220 may execute one or more processes to allow a user to trade in stocks, manage a loan account, transfer funds to/from a bank account, or set up a trust account, among many others.

Search module 222 may be utilized execute one or more processes for searching financial application data within the financial application management device 200. Accordingly, search module 222 may search for information based on one or more account numbers, transaction dates, client identifiers, or search strings, among others. Those of ordinary skill in the art will understand that search module 222 may utilize any search algorithm known in the art, and without departing from the disclosures described herein.

In one implementation, and as previously described, consolidated application module 210 may be configured/adapted based upon a user type identified by visibility module 206. As such, one or more of modules 212-222 may not be accessible (may not be visible on a user interface) to a given user (such as a customer of the financial institution, a fiduciary, or a broker-dealer user). In another example, all of modules 212-222 may be visible to a user of device 200, and the interface generated for display, by consolidated application module 210, may provide adapted access to one or more sub-applications, such as applications 232a-232f, described below.

In one example, a user may interact with a selected one or more of modules 212-222 such that interaction with the selected one or more modules may access one or more sub-applications. As such, consolidated application module 210 may communicate with a sub-applications module 228, wherein said sub-applications module 228 may have a consolidated application database 230, otherwise referred to as a consolidated user information database 230, and a plurality of applications 232a-232f In one example, database 230 comprises a consolidated repository of information available across a plurality of applications provided by modules 212-222 and sub-applications 232a-232f. As such, database 230 may store information for a plurality of different users, wherein only a portion of the information stored in database 230 may be made accessible to a user based upon an identified user type, identified by visibility module 206, and governed by one or more visibility rules stored in financial regulator rules database 208. Accordingly, database 230 may utilize memory hardware of any known type. For example, database 230 may comprise, among others, one or more hard disk drives (HDDs), solid state drives (SSDs), optical disks, tape drives, flash memory, random access memory (RAM), read-only memory (ROM), or combinations thereof. Additionally, database 230 may utilize any known file system, and the like.

Applications 232a-232f represent a plurality of sub-applications/functions available to one or more of modules 212-222. Accordingly, upon interaction with one or more of modules 212-222, one or more of sub-applications 232a-232f may be accessible to the user. As such, the one or more sub-applications 232a-232f may represent lower-level processes executed by one or more of modules 212-222. For example, sub-applications 232a-232f may comprise one or more processes: for opening/closing a financial institution account, changing information associated with an account, storing notes related to a user of the device 200, modeling of stock trading performance, cash management, information related to potential new clients of the financial institution, ordering new securities products, among many others. Those of ordinary skill in the art will recognize various additional sub-applications that may be implemented as one or more of sub-applications 232a-232f without departing from the scope of the disclosures described herein.

In one example, the integrated financial application management device 200 provides access to a fiduciary custody platform 234 and a broker-dealer custody platform 236. Accordingly, access to either platform 234 or platform 236 may be provided based upon an identified user type, as identified by visibility module 206. Accordingly, in one implementation, fiduciary custody platform 234 comprises one or more processes configured to support fiduciary services. In this way, fiduciary custody platform 234 may execute one or more processes to facilitate costs processing, third-party trading, asset servicing, regulatory reporting, issues related to taxation, and the like. As such, those of ordinary skill in the art will recognize various additional and/or alternative functions that may be provided by a fiduciary custody platform 234, without departing from the disclosures described herein.

In one implementation, broker-dealer custody platform 236 comprises one or more processes configured to support broker-dealer services. As such, those of ordinary skill in the art will recognize various processes that may be executed by a broker-dealer custody platform, and which may be integrated into broker-dealer custody platform 236 without departing from the disclosures described herein in relation to the integrated financial application management device 200. Specifically, the functionality provided by a broker-dealer custody platform 236 may include, among others, processing related to taxation requirements, and provision of financial statements, among many others.

FIG. 2B schematically depicts the integrated financial application management device 200 of FIG. 2. In particular, FIG. 2B schematically depicts the device 200 as adapted for a fiduciary user. Accordingly, the schematic depiction of device 200 in FIG. 2B omits the broker-dealer interface module 204, the broker-dealer custody platform 236, and schematically depicts consolidated application module 210 as providing access to modules 212, and 216-222, but without the financial product summary module 214. Further, sub-applications module 228 is schematically depicted as being adapted to provide access to applications 232a, 232c, and 232f, but without 232b, and 232d-232e. Accordingly, those of ordinary skill will recognize that the schematic depictions of FIG. 2B are merely representative of the device 200 as adapted to provide one exemplary tailored user interface for a fiduciary user. As such, various alternative adaptions of device 200, providing various alternative tailored interfaces (including/omitting one or more additional and/or alternative modules and/or sub-applications) may be utilized without departing from the scope of the disclosures described herein.

FIG. 2C schematically depicts the integrated financial application management device 200 of FIG. 2. In particular, FIG. 2C schematically depicts device 200 as adapted for a broker-dealer user. Accordingly, the schematic depiction of device 200 in FIG. 2C schematically omits the fiduciary interface module 202, the fiduciary custody platform 234, and schematically depicts consolidated application module 210 as providing access to an application module 260, wherein application module 260 may comprise one or more of those modules 212-222 from FIG. 2B, and additionally or alternatively, one or more applications specific to broker-dealer operations. Further, sub-applications module 228 is schematically depicted as providing adapted access to sub-applications 232b, 232e, and 232f. Similarly to FIG. 2B, those of ordinary skill in the art will recognize that the schematic depictions of FIG. 2C merely represent device 200 as adapted to generate one exemplary tailored user interface for a broker-dealer user. Various alternative adaptions of device 200 may be utilized to generate alternative tailored interfaces (including/omitting one or more additional and/or alternative modules and/or sub-applications), and may be utilized without departing from the scope of the disclosures described herein.

Furthermore, those of ordinary skill in the art will recognize that FIG. 2, FIG. 2B, and FIG. 2C describe various modules (202-232) that may be utilized to generate one or more adapted user interfaces configured to provide access to various software applications/functions. As such, those of ordinary skill in the art will recognize that the user interfaces generated by device 200 may be configured for display on any display type, and utilizing any formatting designs and/or conventions, without departing from the scope of the disclosures described herein. As such, FIG. 2 schematically depicts those modules 202-232 utilized to generate one or more interfaces, and does not represent the interface final display typesetting, coloring, layouts, and the like, wherein any such display settings may be utilized with the disclosures described herein.

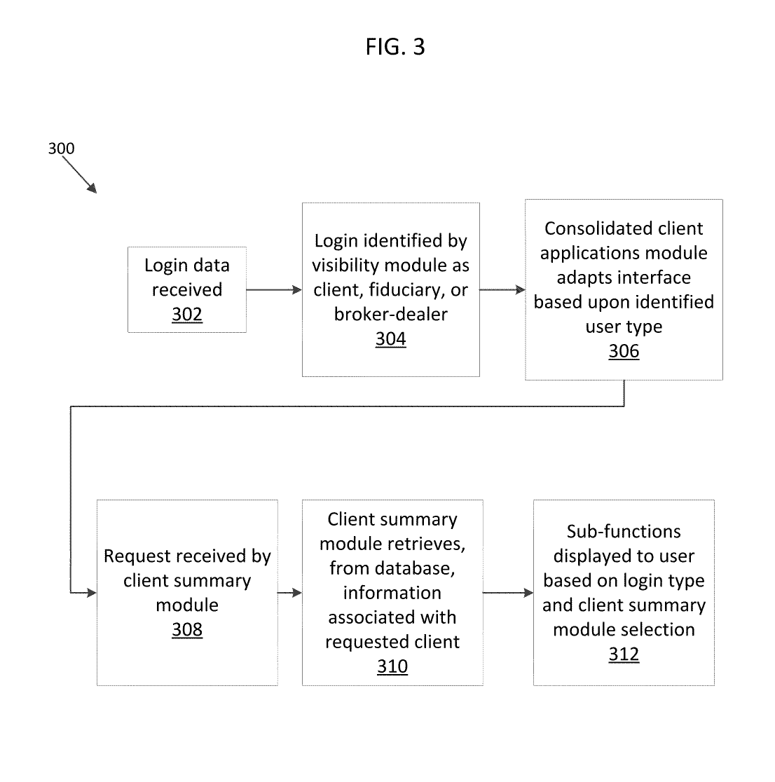

FIG. 3 is a flowchart diagram of a process 300 utilizing an integrated financial application management device, such as device 200, to provide access to client summary information. In particular, block 302 of process 300 represents one or more processes executed by a visibility module, such as module 206 from FIG. 2, to receive login credentials from a user. Accordingly, block 304 represents one or more processes to identify, by the visibility module, the user as, among others, a client of a financial institution, a fiduciary associated with the financial institution, or a broker-dealer associated with the financial institution. Block 306 represents one or more processes executed by a consolidated application module, such as module 210 from FIG. 2, to adapt a user interface based on the identified user type, wherein said adaption may comprise making available/omitting one or more financial applications based on the identified user type.

Block 308 of process 300 represents one or more processes executed to receive, by a client summary module, such as module 212 from FIG. 2, a request for a summary of information associated with a client of a financial institution. This information may include, among others, all financial products associated with the identified client, a schedule of actions to be carried out to service the financial products associated with the identified client, a summary of the correspondences between the financial institution and the identified client, biographic and/or contact information associated with the identified client, or combinations thereof. In response, and at block 310, the client summary module retrieves the requested information from a database, such as consolidated application database 230 from FIG. 2. In one example, upon receipt of the client information from the database 230, process 300 proceeds to block 312, wherein the interface provides access to one or more sub-functions/sub-applications, based upon the user type identified at block 304, and on the selection, by the user, of the client summary module. Accordingly, the sub-functions may provide for further analysis of the information received in relation to the requested client information.

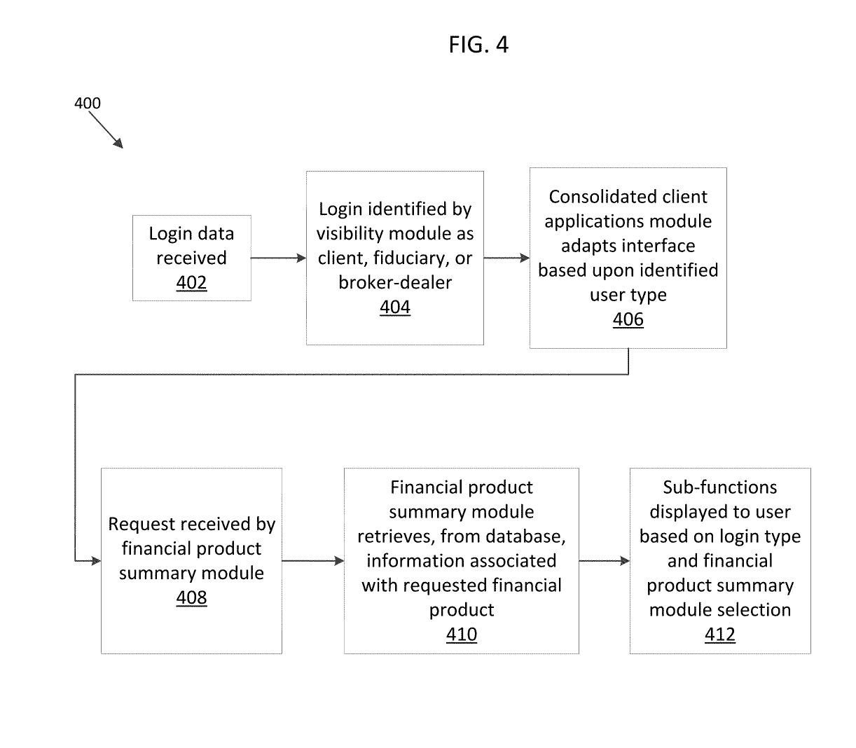

FIG. 4 is a flowchart diagram of a process 400 utilizing an integrated financial application management device, such as device 200, to provide access to information associated with financial products purchased by a user. In particular, block 402 of process 400 represents one or more processes executed by a visibility module, such as module 206 from FIG. 2, to receive login credentials from a user. As previously described, said login credentials may include, among others, a password, an IP address, or a security key, or combinations thereof. Accordingly, block 404 of process 400 represents one or more processes executed by the visibility module to identify the user as a client of a financial institution, a fiduciary user associated with the financial institution, or a broker-dealer user associated with the financial institution, among others. Block 406 of process 400 represents one or more processes executed by a consolidated application module, such as module 210 from FIG. 2, to adapt a user interface based on the identified user type, wherein said adaption may include making available/omitting one or more financial applications, based on the identified user type.

Block 408 of process 400 represents one or more processes executed to receive, by a financial product summary module, such as module 214 from FIG. 2, a request for a summary of financial performance of one or more financial products associated with a client of the financial institution. In response, and at block 410, the financial product summary module retrieves the requested information from a database, such as database 230 from FIG. 2. Upon receipt of the financial information from the database, process 400 proceeds to block 412, wherein the interface provided by consolidated application module 210 from FIG. 2, is further adapted to provide personalized/customized access to one or more sub-functions/sub-applications, based on the user type identified at block 404, and on the selection, by the user, of the financial product summary module.

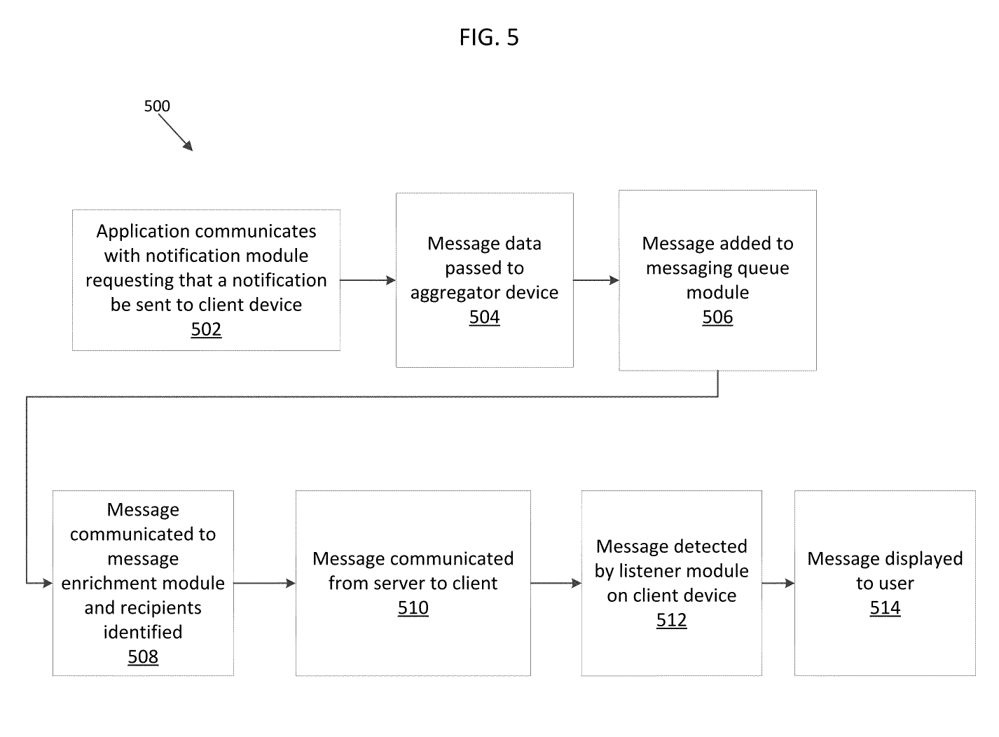

FIG. 5 is a flowchart diagram of a notification process 500. In particular, process 500 may be utilized to provide push notifications to a user of the integrated financial application management device 200 from FIG. 2. Block 502 of process 500 represents one or more processes, executed by an application, to communicate with a notification module, such as notification module 216 from FIG. 2, requesting that a notification message be sent to a user device. Accordingly, the requesting application may be one or more of those applications associated with the consolidated application module 210 from FIG. 2, or the one or more sub-applications 232a-232f associated with sub-applications module 228. Additionally, the type of notification message requested to be sent to a user device may comprise any notification type including, among many others, a reminder related to one or more actions to be taken on behalf of a client of a financial institution, or an update related to a performance of a financial product associated with a user of the integrated financial application management device 200. In one example, the client device to which a notification may be communicated may include, among others, a desktop computer, a laptop computer, or a mobile device (including, among others, a tablet or a smart phone). Furthermore, those one or more processes executed at block 502 of process 500 may include receipt of a message payload comprising a data set (message data) to be delivered to the user.

Block 504 of process 500 executes one or more processes to communicate the received message data to an aggregator device. Accordingly, the aggregator device may comprise one or more software processes to consolidate messages from one or more requesting applications (applications associated with consolidated application module 210 and/or sub-applications module 228). Block 506 of process 400 executes one or more processes to add the message data to a messaging queue module. Those of ordinary skill in the art will recognize various messaging queue processes that may be implemented in process 500 without departing from the scope of the disclosures described herein. Accordingly, said messaging queue module may execute, among others, a first-in-first-out (FIFO) queue. In another implementation, block 506 of process 500 may add the message data to a stack data type.

Block 508 of process 500 represents one or more processes executed to communicate the message data to an enrichment module, wherein said enrichment module is utilized to identify recipients of the message. In one example, recipients of the message data may be identified based upon user types, wherein the application requesting delivery of the push notification may be associated with, among others, users of a particular type (clients of a financial institution, fiduciary user, broker-dealer user, among others), a specific group of users (all clients associated with a specific financial product, all clients associated with a particular geographic location, all clients associated with investments having a value over a threshold amount, among many others), or an individual user, or combinations thereof.

In one example, and at block 510 of process 500, the message data is communicated from a server device to a client device, wherein routing of the messages is based upon a specific IP address. Accordingly, block 510 represents one or more processes executed to identify an IP address associated with those recipients identified at block 508.

In one example, a client device, such as a computer device associated with a user of the integrated financial application management device 200 from FIG. 2, is running a listener module. As such, those of ordinary skill in the art will recognize various implementations of listeners that may be employed without departing from the disclosures described herein. As such, and at block 512 of process 500, the message data from the requesting application is detected by a listener module running on a client device associated with the user of the integrated financial application management device 200. Upon detection of the message data, and at block 514 of process 500, the message information is configured for display to a user.

The present disclosures provide technical advantages. As noted above, an integrated financial application management device 200 provides a consolidated interface for users of different types, wherein said different user types may be subject to different regulations governing types of financial information to which they may have access. Accordingly, the integrated financial application management device 200 provides a unified input interface and repository for client information associated with clients of a financial institution. As such, where financial regulations may previously have caused the financial institution to maintain separate, duplicated financial applications and information for users of different types, such as client users, fiduciary users, and broker-dealer users, the integrated financial application management device 200 allows for consolidation of resources, and associated improvements in financial management efficiencies.

In one aspect, this disclosure relates to an apparatus having a processor in communication with a non-transitory computer-readable medium with computer-executable instructions that generate and display an interface providing access to financial applications based upon a credential corresponding to login information received from a user. The computer-executable instructions also retrieve data associated with the user, from a consolidated application database, for input into a selected financial application, and generate an interface showing functions available to the user, based on the selected financial application and the login information associated with the user.

In another aspect, this disclosure includes a computer-implemented method for providing a consolidated application interface for a financial institution. The method generates for display, using an application module, an interface that provides access to financial applications, wherein the financial applications are accessible based on login data received from a user of the consolidated application interface. The computer-implemented method further comprises inputting data associated with the user into a selected financial application, wherein the data is stored in a consolidated application database accessible to the financial applications, and generating an interface having functions available for selection by the user based upon the selected financial application and the received login data.

In yet another aspect, this disclosure relates to one or more non-transitory computer-readable media having instructions that, when executed, generates an interface providing access to financial applications based upon a credential corresponding to received login information. The instructions further include importing data associated with user into a selected application, wherein the data is stored in the consolidated application database, as well as generating function interface having a function available for selection by the user based upon the selected application from the received login data.

The various embodiments described herein may be implemented by general-purpose or specialized computer hardware. In one example, the computer hardware may comprise one or more processors, otherwise referred to as microprocessors, having one or more processing cores configured to allow for parallel processing/execution of instructions. As such, the various disclosures described herein may be implemented as software coding, wherein those of skill in the computer arts will recognize various coding languages that may be employed with the disclosures described herein. Additionally, the disclosures described herein may be utilized in the implementation of application-specific integrated circuits (ASICs), or in the implementation of various electronic components comprising conventional electronic circuits (otherwise referred to as off-the-shelf components). Furthermore, those of ordinary skill in the art will understand that the various descriptions included in this disclosure may be implemented as data signals communicated using a variety of different technologies and processes. For example, the descriptions of the various disclosures described herein may be understood as comprising one or more streams of data signals, data instructions, or requests, and physically communicated as bits or symbols represented by differing voltage levels, currents, electromagnetic waves, magnetic fields, optical fields, or combinations thereof.

One or more of the disclosures described herein may comprise a computer program product having computer-readable medium/media with instructions stored thereon/therein that, when executed by a processor, are configured to perform one or more methods, techniques, systems, or embodiments described herein. As such, the instructions stored on the computer-readable media may comprise actions to be executed for performing various steps of the methods, techniques, systems, or embodiments described herein. Furthermore, the computer-readable medium/media may comprise a storage medium with instructions configured to be processed by a computing device, and specifically a processor associated with a computing device. As such the computer-readable medium may include a form of persistent or volatile memory such as a hard disk drive (HDD), a solid state drive (SSD), an optical disk (CD-ROMs, DVDs), tape drives, floppy disk, ROM, RAM, EPROM, EEPROM, DRAM, VRAM, flash memory, RAID devices, remote data storage (cloud storage, and the like), or any other media type or storage device suitable for storing data thereon/therein. Additionally, combinations of different storage media types may be implemented into a hybrid storage device. In one implementation, a first storage medium may be prioritized over a second storage medium, such that different workloads may be implemented by storage media of different priorities.

Further, the computer-readable media may store software code/instructions configured to control one or more of a general-purpose, or a specialized computer. Said software may be utilized to facilitate interface between a human user and a computing device, and wherein said software may include device drivers, operating systems, and applications. As such, the computer-readable media may store software code/instructions configured to perform one or more implementations described herein.

Those of ordinary skill in the art will understand that the various illustrative logical blocks, modules, circuits, techniques, or method steps of those implementations described herein may be implemented as electronic hardware devices, computer software, or combinations thereof. As such, various illustrative modules/components have been described throughout this disclosure in terms of general functionality, wherein one of ordinary skill in the art will understand that the described disclosures may be implemented as hardware, software, or combinations of both.

The one or more implementations described throughout this disclosure may utilize logical blocks, modules, and circuits that may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. Functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

Accordingly, it will be understood that the invention is not to be limited to the embodiments disclosed herein, but is to be understood from the following claims, which are to be interpreted as broadly as allowed under the law.

What is claimed is:

1. An apparatus, comprising:
a processor; and
a non-transitory computer-readable medium comprising computer-executable instructions that when executed by the processor are configured to:
receive, by a visibility module, login data from a user;
generate for display, by a consolidated application module, an interface providing access to a first financial application and a second financial application from a plurality of financial applications, wherein access to the first and the second financial applications is provided based upon a credential corresponding to the received login data;
input data associated with the user into a selected application, selected by the user from the first and the second financial applications, wherein the inputted data is stored in a consolidated application database; and
generate for display, a function interface having a function available for selection by the user, based on the selected application and the received login data.

2. The apparatus of claim 1, wherein the login data identifies the user as a customer of a financial institution, a fiduciary user, or a broker-dealer user.

3. The apparatus of claim 2, wherein access to the first application and the second application is based on an access rule provided by a third-party financial regulator based on the credential corresponding to the received login data.

4. The apparatus of claim 1, wherein the non-transitory computer-readable medium further comprises computer-executable instructions that when executed by the processor are configured to:
generate for display, based on the received login data, a financial custody platform.

5. The apparatus of claim 1, wherein the selected application is configured to generate for display, data for a plurality of financial products associated with a customer of a financial institution.

6. The apparatus of claim 1, wherein the non-transitory computer-readable medium further comprises computer-executable instructions that when executed by the processor are configured to:
generate for display to the user, by a notification module, a push notification based on the received login data.

7. The apparatus of claim 1, wherein the selected application is configured to generate for display, based on the received login data, information associated with correspondences between a financial institution and a customer of a financial institution.

8. A computer-implemented method for providing a consolidated application interface for a financial institution, comprising:
receiving, by a visibility module, login data from a user;
generating for display, by an application module, an interface providing access to a first financial application and a second financial application, wherein the first and the second financial applications are accessible based upon a job function corresponding to the received login data;
inputting data into a selected application, selected from the first and the second financial applications, wherein the inputted data is stored in a consolidated user information database accessible to the first and the second financial applications; and
generating for display, a function interface having a function available for selection by the user, wherein the function is based upon the selected application and the received login data.

9. The method of claim 8, wherein the login data identifies the user as a customer of a financial institution, a fiduciary user, or a broker-dealer user.

10. The method of claim 9, wherein access to the first application and the second application is based on an access rule provided by a third-party financial regulator based on the job function corresponding to the received login data.

11. The method of claim 8, further comprising:
generating for display, based on the received login data, a financial custody platform.

12. The method of claim 8, wherein the selected application is configured to generate for display, data for a plurality of financial products associated with a customer of a financial institution.

13. The method of claim 8, further comprising:
generating for display to the user, by a notification module, a push notification based on the received login data.

14. The method of claim 8, wherein the selected application is configured to generate for display, based on the received login data, information associated with correspondences between a financial institution and a customer of a financial institution.

15. One or more non-transitory computer-readable media having instructions stored thereon that, when executed, cause at least one computing device to:
receive, by a visibility module, login data from a user;
generate for display, by a consolidated application module, an interface providing access to a first financial application and a second financial application from a plurality of financial applications, wherein access to the first and the second financial applications is provided based upon a credential corresponding to the received login data;
input data associated with the user into a selected application, selected by the user from the first and the second financial applications, wherein the inputted data is stored in a consolidated application database; and
generate for display, a function interface having a function available for selection by the user, based upon the selected application and the received login data.

16. The one or more non-transitory computer-readable media of claim 15, wherein the login data identifies the user as a customer of a financial institution, a fiduciary user, or a broker-dealer user.

17. The one or more non-transitory computer-readable media of claim 16, wherein access to the first application and the second application is based on an access rule provided by a third-party financial regulator based on the credential corresponding to the received login data.

18. The one or more non-transitory computer-readable media of claim 15, wherein the instructions further cause the at least one computing device to:
generate for display, based on the received login data, a financial custody platform.

19. The one or more non-transitory computer-readable media of claim 15, wherein the selected application is configured to generate for display, data for a plurality of financial products associated with a customer of a financial institution.

20. The one or more non-transitory computer-readable media of claim 15, wherein the instructions further cause the at least one computing device to:
generate for display to the user, by a notification module, a push notification based on the received login data.
